(19) United States
(12) Patent Application Publication
(10) Pub. No.: US 2007/0065592 A1
(43) Pub. Date: Mar. 22, 2007

(54) Ultrasonically-assisted bonding of plastics to surfaces of solid material and product formed thereby

(75) Inventors: Qingyou Han, Knoxville, TN (US); Siqun Wang, Knoxville, TN (US)

Correspondence Address: MICHAEL E. MCKEE;Attorney at Law, 804 Swaps Lane, Knoxville, TN, 37923, US

(73) Assignee: UT-Battelle, LLC

(21) Appl. No.: 11/228,774

(22) Filed: Sep. 16, 2005

(51) Int. Cl. B05D 3/00; B06B 1/00; B05D 1/18

(52) U.S. Cl. 427/398.1; 427/600; 427/430.1

(57) ABSTRACT

A method of bonding plastic or polymer to a lignocellulosic material, such as wood, flax, sisal or kenaf fibers, having voids disposed across the surfaces thereof utilizes an ultrasonic radiator to induce ultrasonic vibrations throughout a mixture or layup of the material and molten plastic or polymer during formation of a resulting product, such as a wood fiber polymer composite product. To this end, molten plastic or polymer and the material are placed into contact with one another, and ultrasonic vibrations which are induced throughout the material and the molten plastic or polymer by the ultrasonic radiator urges the plastic or polymer to flow into the voids defined across the surface of the material so that when the plastic or polymer is cooled to a solid condition, the plastic or polymer is in a strong interlocked relationship with the material at the material/plastic or material/polymer interface.

This invention was made with Government support under Contract No. DE-AC05-00OR22725 awarded by the U.S. Department of Energy to UT-Battelle, LLC, and the Government has certain rights to the invention.

### BACKGROUND OF THE INVENTION

This invention relates generally to the coating or construction of solid materials with plastics or polymers and relates, more particular, to the coating or construction of materials with plastics or polymers.

Materials, such as wood fiber polymer composites (WFPC) have attracted attention as a combination of wood and plastic waste and as a product comprising water-resistant, wood-based materials devoid of formaldehyde-based adhesives. Moreover, the manufacture of wood-plastic composites commonly requires less capital investment and is a rural-community-based approach for utilizing recyclable plastic materials.

Perhaps the greatest growth potential for WFPCs is in building products that have limited structural requirements, such as decking, fencing, industrial flooring, landscape timber, railings, and molding products. According to a study conducted in 2001, the WFPC market totaled about 320,000 metric tons (i.e. 700 million pounds), and is expected to more than double within the near future. Presently, the decking market is the largest and fastest growing WFPC market. While WFPC decking material might currently be more expensive than pressure-treated wood, it is still an attractive material because of its low maintenance requirements, absence of cracks or splinters, and high durability.

Mechanical properties of WFPCs, such as creep resistance, stiffness, and strength, are consistently lower than those of solid wood and composite wood panels. Hence, these composites are not currently being used in applications that require considerable structural performance. For example, WFPCs are used for deck boards, but not for deck substructure. It would be desirable to provide more highly engineered WFPCs having greater structural performance and a more efficient design.

Wood fiber polymer composites (WFPCs) are normally produced by mixing wood fiber with polymer, or by adding wood fiber as filler in a polymer matrix, and the pressing or molding the mixture under high pressure and temperature. Most polymers, especially thermoplastics, are non-polar (hydrophobic) substances that are not chemically compatible with polar (hydrophilic) substances so that a less-than-desirable adhesion exists between the polymer and the wood fiber in a conventionally-produced WFPC. Since wood fiber (or any other natural material) is a porous material, the physical interlocking of a polymer into the macro- and micro-regularities of the wood surface is one of the major factors in adhesion. Moreover, this physical interlocking also determines the interfacial bonding area. However and in part because of the relatively high molecular weight of polymers and the inferior wettability qualities of polymers and wood surfaces, polymers have heretofore not interlocked with wood fibers to the greatest extent possible in conventionally-produced WFPCs.

It is known that ultrasonic (i.e. high frequency vibratory) energy can be used to improve bonding characteristics in polymers. For example and as described in U.S. Pat. No. 6,764,637, ultrasonic energy can be used to join a solidifiable liquid polymeric material to a solid material to produce a solid article. In the method, the solid material is contacted with the liquid polymeric material at an interface. Ultrasonic energy is applied so that the energy reaches the interface between the contacting solid material and liquid polymeric material. A joint is formed at the interface by allowing or causing the liquid polymeric material to solidify, to produce a solid article comprising the solidified polymeric material joined to the solid material.

Furthermore, a method is described in pending U.S. patent application Ser. No. 10/113,798 for ultrasonically bonding thermoplastic materials together wherein the method involves a melt-compatible thermoplastic material. In this method, at least one of the thermoplastic materials to be bonded are preheated prior to entering an ultrasonic bonding apparatus so that the bond strength which is ultimately established between the materials during the ultrasonic bonding process is increased. Materials which can be suitably bonded with this method include elastic spunbond laminates, such as, for example, vertical filament stretch-bonded laminates (VF SBL) and continuous filament stretch-bonded laminates (CF SBL). Additionally, films, woven and other nonwoven webs and/or solid blocks of ultrasonically bondable substrates may also be bonded by this method.

It is an object of the present invention to provide a new and improved method for bonding the components of a wood fiber polymer composite whose resulting composition is stronger and possesses a more efficient design than does a conventionally-produced WFPC and a product resulting from the method.

Another object of the present invention is to provide such a method wherein a WFPC composition which results therefrom possesses a higher interfacial bonding area between the wood fibers and the polymer than has been achievable in conventionally-produced WFPCs.

Still another object of the present invention is to provide such a method which is well-suited for bonding plastics or polymers to or for coating plastics or polymers upon any lignocellulosic material (e.g. wood) or other material which is chemically incompatible with plastic or polymer and which possesses voids (either naturally-occurring or artificially-formed) disposed across the surface of the material.

Yet still another object of the present invention is to provide such a method which utilizes ultrasonic energy.

A further object of the present invention is to provide such a method which is uncomplicated to perform, yet effective in operation.

### SUMMARY OF THE INVENTION

This invention resides in a method and product resulting from the method for bonding plastic or polymer to the surface of a material having voids disposed across the surface thereof.

The method of the invention includes the steps of providing an amount of plastic or polymer in a molten condition, and then placing the amount of molten plastic or polymer in contact with a material having voids disposed across the surface thereof. Ultrasonic vibrations are then utilized to urge the molten plastic or polymer into the voids disposed across the surface of the material. The power density of the vibrations generated during the utilizing step is large enough to create cavitations within the molten plastic or polymer. During cavitation, microscopic bubbles form and collapse which, in turn, generate millions of shock waves, eddies and extremes in pressures and temperatures throughout the molten plastic or polymer. These generated effects combine to urge the molten plastic or polymer into the small voids disposed across the surface of the material. By permitting the product to thereafter cool to a hardened condition, the presence of the plastic or polymer within the voids enhances the interlocked relationship between the plastic or polymer and the material.

While the method of the invention is well-suited for bonding plastic or polymer to any of a number of classes of solid materials having voids (which can be naturally-occurring or artificially-formed) disposed along the surfaces thereof, the method is particularly well-suited for bonding plastic or polymer to the surfaces of materials, such as porous lignocellulosic material (e.g. wood, flax, sisal, kenaf fibers) which are not chemically compatible with plastic or polymer. In sharp contrast to methods such as those which involve a bonding of plastic or polymers to chemically-compatible materials through a bonding of the molecular structures of the materials, the method of this invention cannot rely upon a bonding of the molecular structures of the plastic or polymer and the material being bonded to the plastic or polymer. Instead, a bond formed with the method of the present invention between a plastic or polymer and a material which is chemically incompatible with the plastic or polymer takes advantage of the voids disposed across the surface of the material so that as the plastic or polymer is urged within the voids during the utilizing step, the plastic or polymer becomes physically interlocked with the material.

### BRIEF DESCRIPTION OF THE DRAWINGS

FIG. 1 is a perspective view of a wood fiber polymer composite structure which has been constructed in accordance with one embodiment of a method of the present invention.

FIG. 2 is a view schematically illustrating a system within which wood and molten polymer are bonded in accordance with an embodiment of the method of the present invention.

FIG. 3 is a view similar to that of FIG. 2 of an another system within which wood and molten polymer are bonded in accordance with an another embodiment of the method of the present invention.

FIG. 4 is a view similar to that of FIG. 2 of a still another system within which wood and molten polymer are bonded in accordance with still another embodiment of the method of the present invention.

FIG. 5 is a perspective view of a technique involving the spray-application of molten plastic to the surface of a wooden substrate.

FIG. 6 is a side elevation view illustrating schematically yet another system within which molten plastic is applied to a series of wooden substrates conveyed through a reservoir of molten plastic.

FIG. 7 is a perspective view of a segment of the FIG. 6 system, but drawn to a slightly larger scale.

### DETAILED DESCRIPTION OF THE ILLUSTRATIVE EMBODIMENTS

Turning now to the drawings in greater detail and considering first FIG. 1, there is illustrated an embodiment, generally indicated 20, of product in the form of a wood fiber polymer composite (WFPC) structure which has been constructed in accordance with an embodiment of a method of the present invention. In particular, the structure 20 includes a mixture of wood fibers 24 and polymer 26 which have been bonded together in a manner which enhances the strength of the structure 20. As will be apparent herein, the wood fibers 24 and polymer 26 are bonded together with the aid of ultrasonic energy while the polymer 24 is in a molten, and thereby plastic, condition. The resulting product 20 can be used in structural applications, such as in a building deck, which requires that the product be more load-supportive than are WFPC products of the prior art, and since the outer surface of the product 20 includes a high percentage of polymer 26, the product 20 resists surface damage and is not likely to require frequent cleaning or painting.

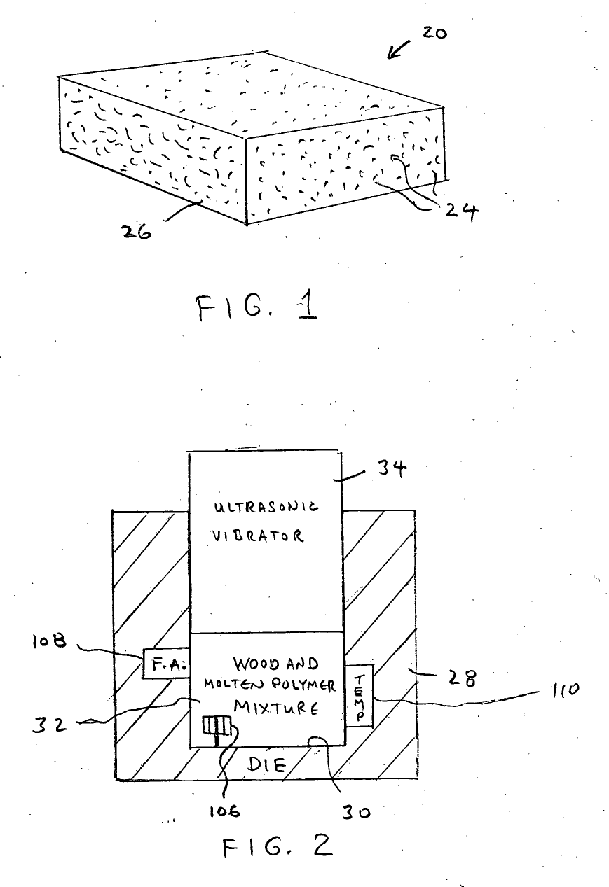

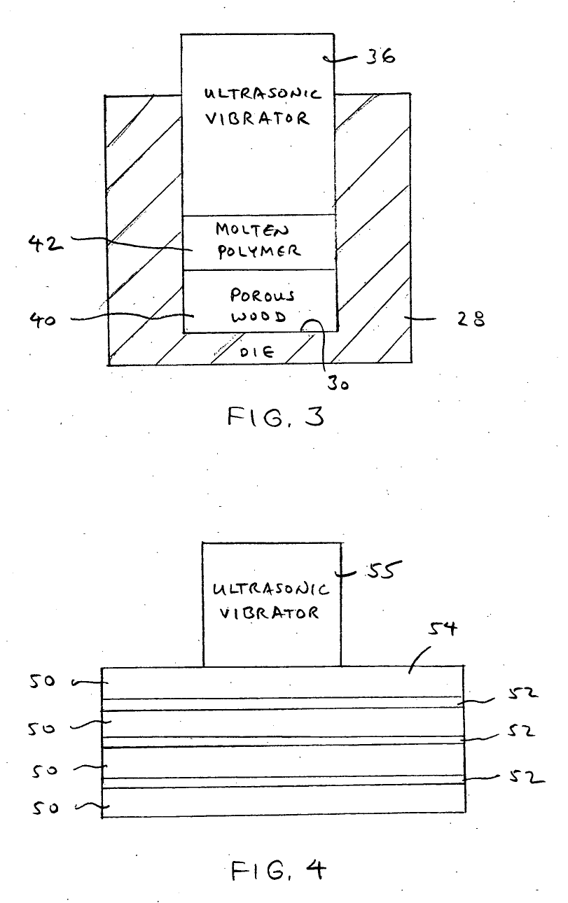

With reference to FIG. 2, one method of making the product 20 can involve the use of a mold or die, indicated 28 in FIG. 2, having a cavity 30 into which a mixture, indicated 32, of wood fiber and molten polymer is placed, or poured. An ultrasonic vibrator, or radiator 34, capable of generating relatively high intensity ultrasonic vibrations is then positioned in working relationship with the mixture 32 so that the mixture 32 is exposed to the ultrasonic energy (i.e. vibrations) induced by the radiator 34. In the FIG. 2 example, the radiator 34 is placed atop the mixture 32 so that when the radiator 34 is actuated, the ultrasonic vibrations generated thereby are transmitted throughout the mixture 32 and, more specifically, throughout the components of the mixture 32.

If desired, the blending of the wood fiber and molten polymer of the mixture 32 can be enhanced by the operation of a motor-driven stirrer 106 which is rotatably mounted within the cavity 30 of the die 28, and a temperature control unit 110 (which can include heating elements and cooling coils) can also be incorporated within the die 28 to help control the temperature of the wood and molten polymer of the mixture 32 as ultrasonic vibrations are transmitted throughout the mixture 32. Still further, a force applicator 108 can also be incorporated within the die 28 for applying a desired, externally-applied force (e.g. compressive or magnetic) to the mixture 32 as ultrasonic vibrations are transmitted thereto. Such externally-applied forces can also be applied to the mixture 32 through the radiator 34.

Wood and wood fibers are characterized by a relatively porous construction which includes small passageways provided, for example, by lumens and pits which are present throughout the material. At the locations at which these small passageways (e.g. the lumens or pits) open out of the surfaces of the wood or wood fibers, relatively small voids (e.g. micro- and macro-regularities) are defined which are disposed across the surfaces thereof. Such voids have walls (which can possess any of a number of various shapes) which provide passageways into which the molten plastic or polymer is permitted to flow with the aid of ultrasonic vibrations.

More specifically, the utilization of the high intensity ultrasonic vibrations generated by the ultrasonic radiator 34 upon the mixture 32 promotes the penetration of the molten polymer into the small voids of the wood and throughout the lumens and pits which are in flow communication with these voids; and the resulting penetration of the molten polymer into the voids of the wood of the mixture 32 creates a better mechanical bond between the wood and the polymer. In other words, as the molten polymer is urged into the voids, the interfacial bonding area between the wood of the mixture 32 and the polymer is increased so that the strength of the resulting interlocked relationship between the wood of the mixture 32 and the polymer is increased, as well. Moreover, the high intensity ultrasonic vibrations generated by the radiator 34 also improves the wetting qualities between polymers and wood surfaces, and this further enhances the bond between the polymer and the wood in the resulting structure 20.

Although the voids which are disposed across the surfaces of the wood fiber in the FIG. 2 mixture 32 occur naturally in the wood fiber, it will be understood that plastic- or polymer-accepting voids can be formed within wood or wood fibers (or some other substrate material) to which molten plastic or polymer is desired to be bonded. For example and before a piece of wood (or some other substrate material) is placed into contact with molten plastic or polymer to be bonded thereto, voids can be formed across the surface of the wood piece by rolling a spiked roller across the surface of the wood piece so that the spikes of the roller penetrate the surface of the wood piece as the roller is rolled thereacross. Alternative methods, such as can involve a roughening of the surface of the wood piece with a cutting or pressing tool, can be used to form voids across the surface of the wood piece for accepting the molten plastic or polymer urged therein by the ultrasonic vibrations generated by an ultrasonic radiator.

As far as the power density of the ultrasonic vibrations generated by the radiator 34 is concerned, it is preferred that the power density of the generated vibrations be large enough to create cavitations within the molten plastic or polymer so that the effect of the cavitations combine to urge the molten plastic or polymer into the voids defined along the surface of the material to which the molten plastic or polymer is to be bonded. More specifically, during cavitation, microscopic bubbles form and collapse so that millions of shock waves, eddies and extremes in pressures and temperatures are generated in the molten plastic or polymer. These generated effects combine to urge the molten plastic and polymer into the surface voids.

In other words, the generation of relatively mild, or low-power, vibrations throughout the molten plastic or polymer will not ordinarily be strong enough to urge the flow of the molten plastic or polymer as deeply into the surface voids as can be achieved by the induction of vibrations within the plastic or polymer which are strong enough to create cavitation within the plastic or polymer. Since the power density required for cavitation will vary between classes of molten plastics or polymer, due for example to differences in characteristics (e.g. viscosity and temperature) of the materials, a minimum value that the power density must be for any type of molten plastic or polymer is difficult to predict. However, as a result of experiments performed to date (many of which have been conducted with a power density of 3.4 kW/in²), applicants have concluded that a power density of at least one MPa is sufficiently high enough to create cavitation in most classes of molten plastics and polymers.

It should also be understood that as a general rule, the higher the power density of the generated vibrations, the better the penetration of the molten plastic or polymer into the voids disposed across the surfaces of the material to which the plastic or polymer is desired to be bonded. The upper limit of the power density of generated vibrations will be dictated by the value of the power density above which is likely to damage the plastic or polymer. Furthermore, the value of the power density utilized during a bonding operation can be adjusted to alter the amount of time needed for the molten plastic or polymer to penetrate the voids disposed across the surface of the material. For example, the power density can be increased to reduce the amount of time necessary for the molten plastic or polymer to penetrate the surface of the material (by way of the surface voids) to a desirable depth.

In another embodiment of the method and with reference to FIG. 3, an ultrasonic vibrator 36 is used to promote the bond between wood and molten polymer through the induction of instantaneous pressure fluctuations. More specifically, an amount 40 of porous wood (e.g. wood fiber) is placed within the cavity 30 of a die 28, and then an amount 42 of molten polymer is placed (e.g. poured) atop the amount 40 of porous wood. The ultrasonic vibrator 36, which is capable of inducing instantaneous pressure fluctuations (whose pressures fluctuate between two pressure levels) through polymer/wood layup positioned within the die 28, is then placed atop the amount 42 of polymer. Ultrasonic energy (in the form of ultrasonic vibrations) is thereafter injected into the molten polymer so that instantaneous pressure fluctuations are directed through the polymer/wood layup. The pressures induced by the vibrator 36 and, more specifically, the higher-level pressures of the resulting fluctuations force the molten polymer into the voids of the porous wood and thereby enhance the bond between the polymer and the wood.

In still another embodiment of the method and with reference to FIG. 4, ultrasonic energy is used to help bond molten polymer to the surface of porous wood in a wood/polymer sandwich. In this connection, a layup 54 is formed with alternating layers, indicated 50, of porous wood (e.g. in the form of sheet or board of wood) and layers 52 of molten polymer.

An ultrasonic vibrator 55 is then placed in working relationship with the wood/polymer layup 54 so that ultrasonic vibrations generated by the vibrator 55 are transmitted throughout each layer 50 or 52 of the layup 54. More specifically, the ultrasonic vibrator 55 is placed atop the uppermost wood layer 50 so that during operation, the vibrator 55 acts directly upon the wood/molten polymer layup 54. Subsequent actuation of the vibrator 55 generates ultrasonic vibrations which are transmitted through each layer 50 of wood and into the layers 52 of molten polymer, and these transmitted vibrations urge the molten polymer to flow into, and thereby penetrate, the voids associated with the porous surface of the wood layer 50 so that the resulting product (comprised of a wood/polymer sandwich) contains a strong bond between the polymer and the wood at the wood/polymer interface.

As an alternative to the structure of the layup 50 described above in connection with FIG. 4, each layer 52 of molten plastic could include a reinforced mat. Such a mat could be either a woven or non-woven thin sheet of fiberglass or a fine metal screen—each of which is incompatible with thermal plastics yet includes voids which extend into the material of the mat from the surfaces thereof. In such an instance, the utilization of ultrasonic energy (applied by means of the vibrator 55) urges the molten plastic to penetrate the voids of the reinforced mats, as well as the voids which open into the surfaces of the wood layers 50. Further still, the layup 54 could be constructed so that a layer 52 of molten plastic, rather than a layer 50 of wood, comprises an outer layer of the layup 54.

It follows from the foregoing that a method has been described for bonding wood (and wood fibers) to molten polymer so that the resulting product (formed after the polymer has been permitted to cool to a hardened condition) exhibits a strong bond between the wood and the polymer. Such a method relies upon the ultrasonic vibrations of a relatively high power density to urge the polymer, while in the molten condition, into the voids (which can include both macro- and micro-regularities) normally associated with the porous surface of the wood or wood fibers. This induced movement or flow of the molten polymer into the surface voids of the wood or wood fibers enhances the interlocked relationship between the polymer and the wood at the wood/polymer interface and increases the area of interfacial bonding.

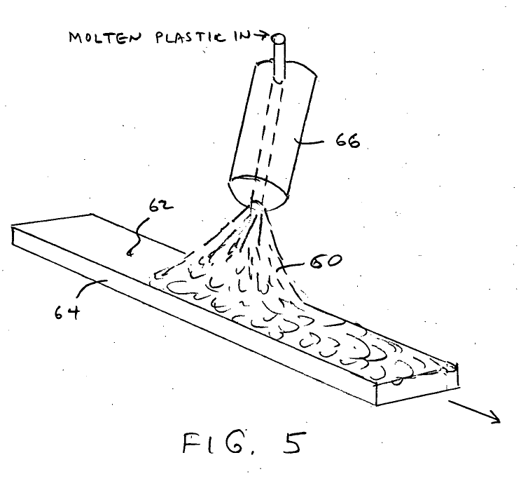

The principles of the present invention can also be applied in various methods for bonding a plastic or polymer, when in a molten condition, to the surface of a wooden substrate or some other material, such as metal, ceramics, or concrete, which possesses voids (either naturally-occurring or artificially-formed) across the surface thereof. For example, there is illustrated in FIG. 5 a method involving the application of a molten plastic 60 to the surface, indicated 62, of a piece 64 of wood in a spraying process. More particularly, the amount of molten plastic 60 is conducted through a stationary ultrasonic radiator 66 and then spray-applied to the wood surface 62 as the wood piece 64 passes beneath the radiator 66. As the molten plastic is spray-applied to the wood surface 62, ultrasonic vibrations are applied to the molten plastic 60 by the radiator 66 so that the plastic is urged to flow into the voids defined across the wood surface 62. When the resulting plastic-coated product is permitted to cool to a hardened condition, the presence of the plastic 60 within the voids disposed across the wood surface 62 securely bonds the plastic 60 to the wood piece 64. The FIG. 5 application of the molten plastic 60 to the wood surface 62 by way of a spray application may be preferred over other methods of applying a plastic coating to the wood surface 62 because of the control that a spray application affords over the thickness of the plastic coating upon the resulting product.

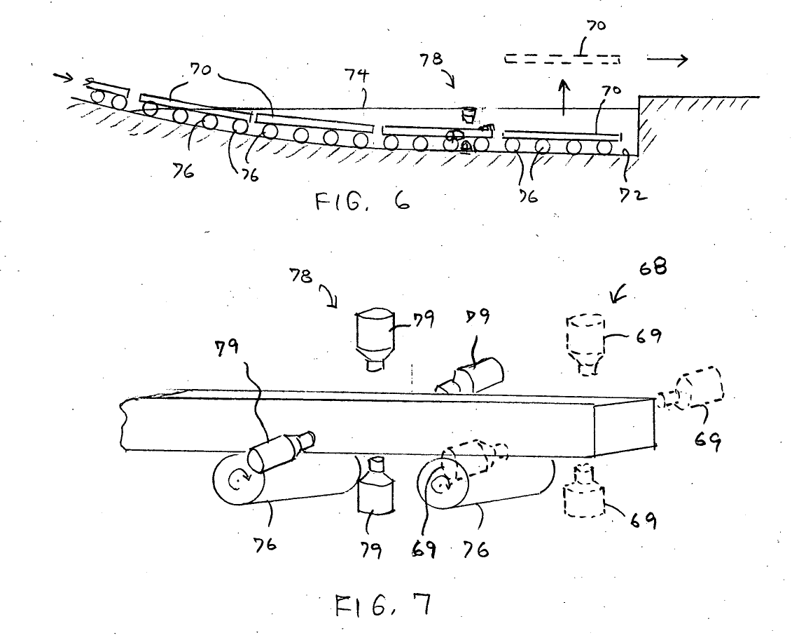

Further still, there is illustrated in FIGS. 6 and 7 the application of molten plastic 74 to the surfaces of a series of wooden pieces 70 as the wooden pieces 70 are conveyed in series through a vat or reservoir, indicated 72, containing the molten plastic 74. In this example, the wooden pieces 70 are arranged in an end-to-arrangement and conveyed through the reservoir 72 of molten plastic 74 along a plurality of rotatably-supported conveyor rollers 76. An ultrasonic radiator system, generally indicated 78, is supported at a workstation within the molten plastic 74 so that ultrasonic vibrations generated by the system 78 urge the molten plastic into the surface voids of each wooden piece 70 being passed through the workstation. In this connection and as best illustrated in FIG. 7, the radiator system 78 includes four radiators 79 which are disposed above, below and on opposite sides of the wooden piece 70 being passed through the workstation so that as each wooden piece 70 is conveyed through the workstation, the ultrasonic vibrations which are generated by the radiators 79 urge the molten plastic 74 to flow into the voids disposed across the top, bottom and side surfaces of the wooden pieces 70. Upon completion of the desired bonding of the molten plastic to a wooden piece 70, that wooden piece 70 is lifted from the reservoir 72 to, for example, the position illustrated in phantom in FIG. 6, to an out-of-the-way position where the plastic which covers the wooden piece 70 is permitted to cool to form a solid coating over the wooden piece 70.

If desired and as illustrated in phantom in FIG. 7, additional, or a second, ultrasonic radiator system, generally indicated 68, can be utilized along with the radiator system 78 for urging the molten plastic 74 into the surface voids of a wooden piece 70 being passed through the workstation at which the systems 78 and 68 are located. As is the case with the radiator system 78, the additional radiator system 68 includes four radiators 69 which are supported at the workstation so as to be disposed above, below and on opposite sides of the wooden piece 70 so that as each wooden piece 70 is conveyed past the radiators 69, ultrasonic vibrations generated thereby urge the molten plastic 74 to flow into the voids disposed across the top, bottom and side surfaces of the wooden pieces 70. The provision of multiple radiator systems 78 and 68 disposed at a single station (or even multiple stations) can permit each wooden piece 70 to be passed through the reservoir 72 at a higher rate of speed than would be the case if only one set of radiators 79 were utilized to urge the molten plastic or polymer into the surface voids of a material. Consequently, the provision of multiple radiator systems within an arrangement such as that illustrated in FIG. 6 is believed to be well-suited for mass production techniques.

The types of plastics or polymers with which this invention is preferably employed includes the plastics and polymers, such as thermoplastics and thermoset polymers, which are not very viscous when in a molten condition. In other words, the method of the present invention is best-suited for use with molten plastics and polymers which would not ordinarily flow deeply into the surface voids of a material without the aid of the ultrasonic vibrations generated by an ultrasonic radiator.

It follows from the foregoing that a method has been described for bonding a plastic or polymer to the surface of a material having voids disposed across the surface thereof. To carry out this method, an amount of plastic or polymer in a molten condition is provided, and the amount of molten plastic or polymer is placed in contact with the material. Ultrasonic vibrations are then directed throughout the molten plastic or polymer so that the molten plastic or polymer is urged into the voids disposed across the surface of the material. The material to which the molten plastic or polymer is bonded can be any of a number of classes of solid materials whose surface (or surfaces) has voids (either naturally occurring or artificially formed) disposed across the surface thereof.

It will be appreciated that the method of the invention is particularly well-suited for bonding a plastic or polymer to a lignocellulosic material or other material which is chemically incompatible with plastic or polymer. In other words, whereas the bonding of chemically-compatible materials commonly involves a bonding of the molecular structures of the materials being bonded, the bond formed between the polymer and the solid material by the method of the present invention relies instead upon the mechanical interlock formed as a consequence of the presence of the polymer throughout the surface voids of the solid material. Since materials which are chemically incompatible with plastic or polymer cannot rely upon any bonding of the molecular structure of the materials being bonded, the method of the present invention is well-suited for bonding plastic or polymers to materials of this class without any need that a compatibilizing material be employed at, or coated upon, the surface of the solid material.

It will be understood that numerous modifications and substitutions can be had to the aforedescribed embodiments without departing from the spirit of the invention. For example, although the aforedescribed embodiments have addressed the bonding of relatively large quantities of plastics or polymers to a material, it will be understood that the desired bonding between the plastic or polymer to a material at the plastic- or polymer-to-material interface can be effected with a smaller quantity (i.e. a coating) of plastic or polymer.

Further still, although the aforedescribed embodiments of FIGS. 2-4 have been shown and described as employing a single ultrasonic radiator which is positioned atop the surface of a wood/polymer mixture or layup, alternative embodiments of the method can employ a plurality of radiators, and such radiators need not act upon the wood/polymer mixture from the top thereof. For example, such radiators can instead act upon the mixture or layer through the bottom thereof or, as in the case of a die having a cavity for holding a wood/polymer mixture, can induce ultrasonic vibrations through the mixture which are transmitted through the sides of the die.

Yet still further, although some of the aforedescribed embodiments have been shown and described as utilizing only ultrasonic vibrations to urge molten plastic or polymer into the surface voids of a material for bonding the plastic or polymer thereto, ultrasonic vibrations can be used in conjunction with or in combination with other means, such as a pressure-applying means, for urging molten plastic or polymer into the surface voids of the material. Accordingly, the aforedescribed embodiments are intended for the purpose of illustration and not as limitation.

1. A method for bonding a plastic or polymer to the surface of a material having voids disposed across the surface thereof, the method comprising the steps of:
providing an amount of plastic or polymer in a molten condition;
placing the amount of molten plastic or polymer in contact with a material having voids disposed across the surface thereof; and
utilizing ultrasonic vibrations to urge the molten plastic or polymer into the voids disposed across the surface of the material wherein the power density of the generated vibrations is large enough to create cavitations within the molten plastic or polymer during this utilizing step.

2. The method as defined in claim 1 wherein the step of utilizing is followed by a step of permitting the plastic- or polymer-to-material to cool to a hardened condition so that the plastic or polymer is securely interlocked with the material at the surface thereof.

3. The method as defined in claim 1 wherein the step of utilizing includes a step of placing an ultrasonic vibrator in working relationship with at least one of the material having voids disposed across the surface thereof and the molten plastic or polymer so that ultrasonic vibrations generated by the ultrasonic vibrator are transmitted through the material and the molten plastic or polymer.

4. The method as defined in claim 3 wherein the ultrasonic vibrator involved in the utilizing step is adapted to induce instantaneous pressure fluctuations through the material having voids disposed across the surface thereof and the molten plastic or polymer, and the step of utilizing includes a step of inducing instantaneous pressure fluctuations in the molten plastic or polymer in contact with the material.

5. The method as defined in claim 1 wherein the step of placing includes a step of placing the material having voids disposed across the surface thereof and the amount of molten plastic or polymer in a superposed relationship so that the step of utilizing acts upon the superposed arrangement of the material and the molten plastic or polymer.

6. The method as defined in claim 1 wherein the step of placing includes a step of constructing a layup of material having voids disposed across surfaces thereof and molten plastic or polymer so that a layer of molten plastic or polymer is disposed between adjacent layers of the material having voids disposed across the surfaces thereof and so that the step of utilizing acts upon the layup of material and the molten plastic or polymer.

7. The method as defined in claim 1 wherein the material to which the plastic or polymer is desired to be bonded includes an amount of fibers and the step of placing the amount of molten plastic or polymer in contact with the material having voids disposed across the surface thereof includes a step of mixing the amount of fibers within the amount of molten plastic or polymer.

8. The method as defined in claim 1 wherein the step of placing includes a step of spraying an amount of molten plastic or polymer upon the surface of the material.

9. The method as defined in claim 1 wherein the step of placing the amount of molten plastic or polymer in contact with a material having voids disposed across the surface thereof includes the steps of conveying the material through the amount of molten plastic or polymer.

10. A product formed by the method of claim 1.

11. A method of bonding a thermoplastic or a thermoset polymer to a material having a surface across which a plurality of voids are disposed, the method comprising the steps of:
providing an amount of a thermoplastic or a thermoset polymer in a molten condition;
placing the surface of the material across which void are disposed and the amount of molten thermoplastic or thermoset polymer in contact with one another; and
utilizing ultrasonic vibrations to urge the molten thermoplastic or thermoset polymer into the voids defined within the surface of the material so that when the molten thermoplastic or thermoset polymer is subsequently cooled to a solid condition, the thermoplastic or thermoset polymer is in an interlocked relationship with the surface of the material across which the voids are disposed, and
wherein the power density of the vibrations generated during the utilizing step is large enough to create cavitations within the molten thermoplastic or thermoset polymer.

12. The method as defined in claim 11 wherein the step of utilizing ultrasonic vibrations includes a step of placing an ultrasonic vibrator in working relationship with the molten thermoplastic or thermoset polymer so that ultrasonic vibrations generated by the ultrasonic vibrator are transmitted through both the material and the molten thermoplastic or thermoset polymer.

13. The method as defined in claim 12 wherein the ultrasonic vibrator involved in the utilizing step is adapted to induce instantaneous pressure fluctuations through the material and the molten thermoplastic or thermoset polymer, and the step of utilizing includes a step of inducing instantaneous pressure fluctuations in the molten thermoplastic or thermoset polymer in contact with the material.

14. The method as defined in claim 11 wherein the step of placing includes a step of placing the material and the amount of molten thermoplastic or thermoset polymer in a superposed relationship so that the step of utilizing acts upon the superposed arrangement of the material and the molten thermoplastic or thermoset polymer.

15. The method of claim 11 wherein the step of placing includes a step of constructing a layup of material and molten thermoplastic or thermoset polymer so that a layer of molten thermoplastic or thermoset polymer is disposed between adjacent layers of the material and so that the step of utilizing acts upon the layup of material and the molten thermoplastic or thermoset polymer.

16. The method as defined in claim 11 wherein the material to which the thermoplastic or thermoset polymer is desired to be bonded includes an amount of fibers and the step of placing the amount of molten thermoplastic or thermoset polymer in contact with the material having voids defined within the surface thereof includes a step of mixing the amount of fibers within the amount of molten thermoplastic or thermoset polymer.

17. The method as defined in claim 11 wherein the step of placing includes a step of spraying an amount of molten thermoplastic or thermoset polymer upon the surface of the material.

18. The method as defined in claim 11 wherein the step of placing the amount of molten thermoplastic or thermoset polymer in contact with the material includes the steps of conveying the material through the amount of molten thermoplastic or thermoset polymer.

19. The method as defined in claim 11 further comprising a step of applying a force to the molten thermoplastic or thermoset polymer for urging the thermoplastic or thermoset polymer into the voids defined within the surface of the material, and the step of applying is carried out with the step of utilizing so that the molten thermoplastic or thermoset polymer is urged into the voids defined within the surface of the material by both the applying step and the utilizing step.

20. The method as defined in claim 11 wherein the power density of the vibrations generated during the utilizing step is at least as great as one mpa.

21. A product formed by the method of claim 11.

22. A method for bonding a plastic or polymer to the surface of a solid material which is chemically incompatible with the plastic or polymer and which has voids disposed across the surface thereof, the method comprising the steps of:
providing an amount of plastic or polymer in a molten condition;
placing the amount of molten plastic or polymer in contact with the solid material which is chemically incompatible with the plastic or polymer and has voids disposed across the surface thereof; and
utilizing ultrasonic vibrations to urge the molten plastic or polymer into the voids disposed across the surface of the solid material wherein the power density of the generated vibrations is large enough to create cavitations within the molten plastic or polymer during this utilizing step.
